(19) United States
(12) Patent Application Publication
(10) Pub. No.: US 2012/0212436 A1
(43) Pub. Date: Aug. 23, 2012

(54) MOBILE ELECTRONIC DEVICE

(75) Inventors: Hiroki KOBAYASHI, Osaka (JP); Hiroyuki OKAMOTO, Osaka (JP)

(73) Assignee: KYOCERA CORPORATION, Kyoto (JP)

(21) Appl. No.: 13/398,769

(22) Filed: Feb. 16, 2012

(30) Foreign Application Priority Data
Feb. 18, 2011 (JP) 2011-032828

(51) Int. Cl. G09G 5/00; G06F 3/041

(52) U.S. Cl. 345/173; 345/1.3

(57) ABSTRACT

A mobile electronic device and methods is disclosed. An operation module receives a start operation performed by a user. The start operation is for a startup of an application program that is unable to start due to duplication. A control module terminates a display of a first screen image on a first display module and displays a second screen image on a second display module, when the start operation is received while the first screen image is displayed on the first display module. The first screen image is based on the first application program and the second screen image is based on a newly started up first application program.

### CROSS-REFERENCE TO RELATED APPLICATION

The present application claims priority under 35 U.S.C. §119 to Japanese Patent Application No. 2011-032828, filed on Feb. 18, 2011, entitled “MOBILE TERMINAL DEVICE”. The content of which is incorporated by reference herein in its entirety.

1. Field

Embodiments of the present disclosure relate generally to mobile electronic devices, and more particularly relate to a mobile electronic device comprising more than one display screen thereon.

2. Background

Mobile electronic devices comprising multiple display screens are able to display information on each display screen based on an executed application program. When a “duplicate startup” that is an application identical to the executed application program that has already been started up is started up again, processing errors may occur. The processing errors may occur because multiple processes are executed in parallel in relation to a single application program, thereby competing with each other during execution and causing the processing errors. Therefore, starting up the duplicate start up may be prohibited.

### SUMMARY

A mobile electronic device and methods are disclosed. An operation module receives a start operation performed by a user. The start operation comprises a startup of a first application program that is unable to start due to duplication. A control module terminates a display of a first screen image on a first display module and displays a second screen image on a second display module, when the start operation is received while the first screen image is displayed on the first display module. The first screen image is based on the first application program and the second screen image is based on a newly started up first application program.

In an embodiment, a mobile electronic device comprises an operation module and a control module. The operation module receives a start operation performed by a user. The start operation comprises a startup of an application program that is unable to start due to duplication. The control module terminates a display of a first screen image on a first display module and display a second screen image on a second display module, when the start operation is received while the first screen image is displayed on the first display module. The first screen image is based on the first application program and the second screen image is based on a newly started up first application program.

In another embodiment, a mobile electronic device comprises a first detection module, a second detection module, an execution module, and a display control module. The first detection module detects inputs on a first display module. The second detection module detects the inputs on a second display module. The execution module executes a first application program and a duplicate program of the first application program in response to the inputs. The display control module causes the second display module to display a first screen image based on the duplicate program, when the duplicate program that cannot be newly executed during execution of the first program, is executed by the execution module for display on the first display module in response to detecting a startup operation by the second detection module.

In a further embodiment, a computer readable storage medium comprises computer-executable instructions for executing a duplicate application program. The method executed by the computer-executable instructions receives an operation performed by a user, the operation related to a startup of an application program unable to start due to duplication. The method executed by the computer-executable instructions further terminates a display of a first screen image on a first display and display a second screen image on a second display, when the operation is received while the first screen image is displayed on the first display. The first screen image is based on the application program and the second screen image is based on the application program.

In an additional embodiment, a computer readable storage medium comprises computer-executable instructions for controlling a screen display. The method executed by the computer-executable instructions displays an screen image based on a program on a second display module, when the program cannot be newly executed while being executed with a first display module as an output destination and a prescribed input related to the program is detected on the second display module.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1 is an illustration of an exploded perspective view of a mobile phone according to an embodiment of the disclosure.

FIGS. 2A-2D are illustrations showing open and closed states of the mobile phone of FIG. 1.

FIG. 3 is an illustration of a functional block diagram of a mobile phone according to an embodiment of the disclosure.

FIG. 4A is an illustration of a display screen showing an E-mail creation screen and a screen listing thumbnail images according to an embodiment of the disclosure.

FIG. 4B is an illustration of a display screen showing an E-mail creation screen and a screen listing thumbnail images according to an embodiment of the disclosure.

FIG. 5 is an illustration of a flowchart showing a screen display control process according to an embodiment of the disclosure.

FIG. 6A is an illustration of a display screen showing an E-mail creation screen, a screen listing thumbnail images, and a webpage screen according to an embodiment of the disclosure.

FIG. 6B is an illustration of a display screen showing an E-mail creation screen, a screen listing thumbnail images, and a webpage screen according to an embodiment of the disclosure.

FIG. 7 is an illustration of a flowchart showing a screen display control process according to an embodiment of the disclosure.

FIG. 8A is an illustration of a display screen showing an E-mail creation screen, a screen listing thumbnail images, and a webpage screen according to an embodiment of the disclosure.

FIG. 8B is an illustration of a display screen showing an E-mail creation screen, a screen listing thumbnail images, and a webpage screen according to an embodiment of the disclosure.

FIG. 9 is an illustration of a flowchart showing a screen display control process according to an embodiment of the disclosure.

FIG. 10 is an illustration of a display screen showing an E-mail creation screen according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, Global Positioning Systems (GPSs) or navigation systems, health equipment, display monitors, or other electronic device that uses a display screen or a touch panel for displaying information.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

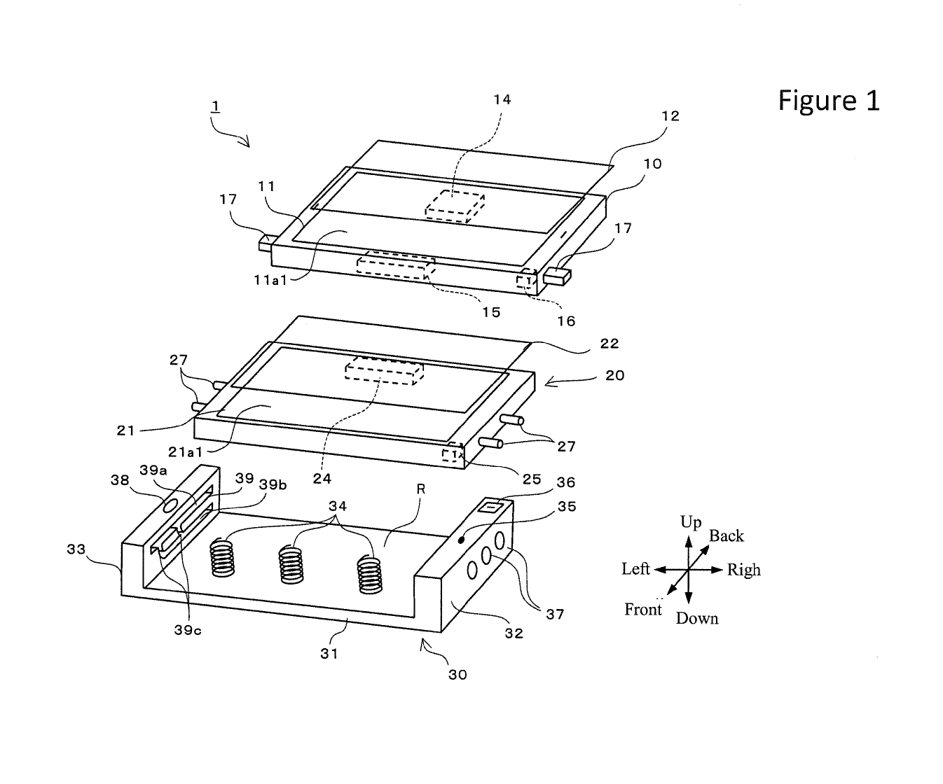

FIG. 1 is an illustration of an exploded perspective view of a mobile phone 1 according to an embodiment of the disclosure. The mobile phone 1 may comprise a first cabinet 10, a second cabinet 20, and a holding body 30 that holds the first cabinet 10 and the second cabinet 20.

The first cabinet 10 may comprise, for example but without limitation, a horizontally long rectangular shape, or other shape. A first touch panel is arranged on the front surface of the first cabinet 10. The first touch panel comprises a first display 11 and a first touch sensor 12.

The first display 11 (first display module 11) is able to display images (screen images) on a first display screen 11a1. The first display 11 comprises a first liquid crystal panel 11a and a first backlight 11b. The first display screen 11a1 is provided on the front surface of the first liquid crystal panel 11a. The first touch sensor 12 is layered over the first display screen 11a1. The first backlight 11b comprises one or multiple light sources and is able to illuminate the first liquid crystal display panel 11a.

The first touch sensor 12 (first detector module) is able to detect inputs made on the first display 11. The first touch sensor 12 may comprise a transparent rectangular sheet, and covers the first display screen 11a1 of the first display 11. The first touch sensor 12 comprises a first transparent electrode and a second transparent electrode arranged in a matrix form. By detecting changes in the capacitance of these transparent electrodes, the first touch sensor 12 is able to detect positions on the first display screen 11a1 that have been touched by a user and output position signals corresponding to those input positions. The act of the user touching the first display screen 11a1 refers to, for example, the user touching the first display screen 11a1 using a contact-carrying member, such as a pen, or their finger. The contact-carrying member or finger touching the first display screen 11a1 may be still or may move. Moreover, a time period during which the contact-carrying member or finger touches the first display screen 11a1 may be short or long.

The first cabinet 10 comprises a camera module 14. A lens window for taking in subject images is provided on the first cabinet 10.

The first cabinet 10 comprises a magnet 15 in the central position near the front surface, and comprises a magnet 16 at the right front corner.

On the rightward surface and leftward surface of the first cabinet 10, a protrusion 17 is provided.

The second cabinet 20 is may comprise, for example but without limitation, a horizontally long rectangular shape, or other shape, and may have approximately the same shape and size as the first cabinet 10. The second cabinet 20 comprises a second touch panel. The second touch panel comprises a second display 21 and a second touch sensor 22.

The second display 21 (second display module) is able to display images (screen images) on the second display screen 21a1. The second display 21 comprises a second liquid crystal panel 21a and a second backlight 21b. The second display screen 21a1 is provided on the front surface of the second liquid crystal panel 21a. The second backlight 21b comprises one or multiple light sources and illuminates the second liquid crystal panel 21a. The first display 11 and the second display 21 may be configured by another display element, such as organic electroluminescent (EL).

The second touch sensor 22 (second detector module) is able to detect inputs made on the second display 21. The second touch sensor 22 may have a similar shape and configuration as the first touch sensor 12. The second touch sensor 22 covers the second display screen 21a1 of the second display 21, detects positions on the second display screen 21a1 touched by the user, and outputs position signals corresponding to those input positions.

The second cabinet 20 comprises a magnet 24 in the central position near the rear surface. The magnet 24 and the magnet 15 are arranged so as to pull one another when in the open state as described below.

The second cabinet 20 comprises a closure sensor 25 on the right front corner. The closure sensor 25 is configured by, for example but without limitation, a hole Integrated Circuit (IC). The closure sensor 25 outputs sensor signals when it detects the magnetic force of the magnet 16. In the closed state (described below), because the magnet 16 of the first cabinet 10 nears the closure sensor 25, sensor signals are output from the closure sensor 25 to a CPU 100. On the other hand, in the open state, because the magnet 16 of the first cabinet 10 is separated from the closure sensor 25, sensor signals are not output from the closure sensor 25.

One axis part 27 is provided on each of both side surfaces of the second cabinet 20.

The holding body 30 comprises a baseplate part 31, a right holding part 32 formed on the right edge of the baseplate part 31, and a left holding part 33 formed on the left edge of the baseplate part 31.

On the baseplate 31, three coil springs 34 are arranged in a row in the longitudinal direction. In the state in which the second cabinet 20 is attached to the holding body 30, the coil springs 34 come into contact with the bottom surface of the second cabinet 20 and provide a force pushing the second cabinet 20 upward.

A microphone 35 and a power key 36 are arranged on the top surface of the right holding part 32. On the top surface of the left holding part 33, a speaker 38 is arranged. On the outward surface of the right holding part 32, multiple hard keys 37 are arranged.

On the inward surfaces of the right holding part 32 and the left holding part 33, guide grooves 39 are formed. The guide grooves 39 comprise an upper groove 39a, a lower groove 39b, and two longitudinal grooves 39c. The upper groove 39a and the lower groove 39b extend in the anteroposterior direction, and the longitudinal grooves 39c extend vertically to connect the upper groove 39a and the lower groove 39b.

If the region bounded by the baseplate part 31, the right holding part 32, and the left holding part 33 is defined as a receiving region R, the axis part 27 is inserted into the lower groove 39b of the guide groove 39 and the second cabinet 20 is arranged inside the receiving region R of the holding body 30. The protrusion 17 is inserted into the upper groove 39a of the guide groove 39, the first cabinet 10 is arranged above the second cabinet 20, and the first cabinet 10 fits into the receiving region R of the holding body 30.

In this way, the first cabinet 10 and the second cabinet 20 are housed and layered vertically inside the receiving region R. In this state, the first cabinet 10 is able to slide forward and backward while being guided by the upper groove 39a. The second cabinet 20 is able to slide forward and backward while being guided by the lower groove 39b. When the second cabinet 20 moves forward and the axis part 27 reaches the longitudinal grooves 39c, the second cabinet 20 is able to slide upward and downward while being guided by the longitudinal grooves 39c.

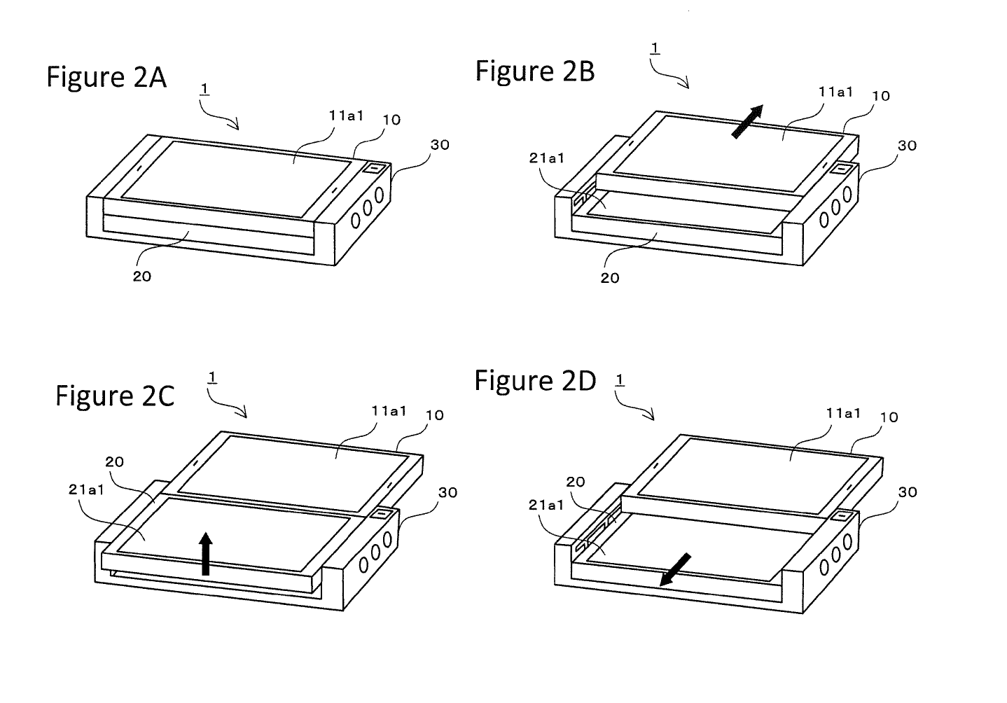

FIGS. 2A-2D are illustrations showing open and closed states of the mobile phone 1.

In the closed state shown FIG. 2A, the first cabinet is layered above the second cabinet 20 and the mobile phone 1 is folded. The closed state corresponds to a first mode in which the second display screen 21a1 is covered by the first cabinet 10. In the closed state, of the two display screens, only the first display screen 11a1 is exposed externally.

The first cabinet 10 moves backward in the direction of the arrow shown in FIG. 2B, and the second cabinet 20 is drawn forward in the direction of the arrow shown in FIG. 2C. As a result, when the closure sensor 25 no longer detects the magnetic force of the magnet 16 and no longer outputs sensor signals, the mobile phone 1 is switched to the open state. In the open state, part of the second display screen 21a1 is visible to the exterior.

When the second cabinet 20 is no longer completely layered with the first cabinet 10, the axis part 27 shown FIG. 1 reaches the longitudinal grooves 39c. The axis part 27 moves along the longitudinal grooves 39c, and the second cabinet 20 becomes able to move upward and downward. As a result of the elastic force of the coil springs 34 and the attractive force of the magnet 15 and the magnet 24, the second cabinet 20 rises.

In FIG. 2D, the second cabinet 20 lines up with and enters close contact with the first cabinet 10, and the second display screen 21a1 becomes the same height as the first display screen 11a1. As a result, the first cabinet 10 and the second cabinet 20 are spread open, and both the first display screen 11a1 and the second display screen 21a1 are exposed externally.

In FIG. 2B, 2C, and 2D, the open state corresponds to a second state in which at least part of the second display screen 21a1 is exposed externally.

As a result of the protrusions 17 moving along the upper grooves 39a of the guide grooves 39 and the axis parts 27 moving along the lower grooves 39b, the longitudinal grooves 39c, and the upper grooves 39a, the state is switched between the closed state and the open state. Therefore, the protrusions 17, the axis parts 27, and the guide grooves 39 may correspond to a switching part capable of switching between the closed state and the open state.

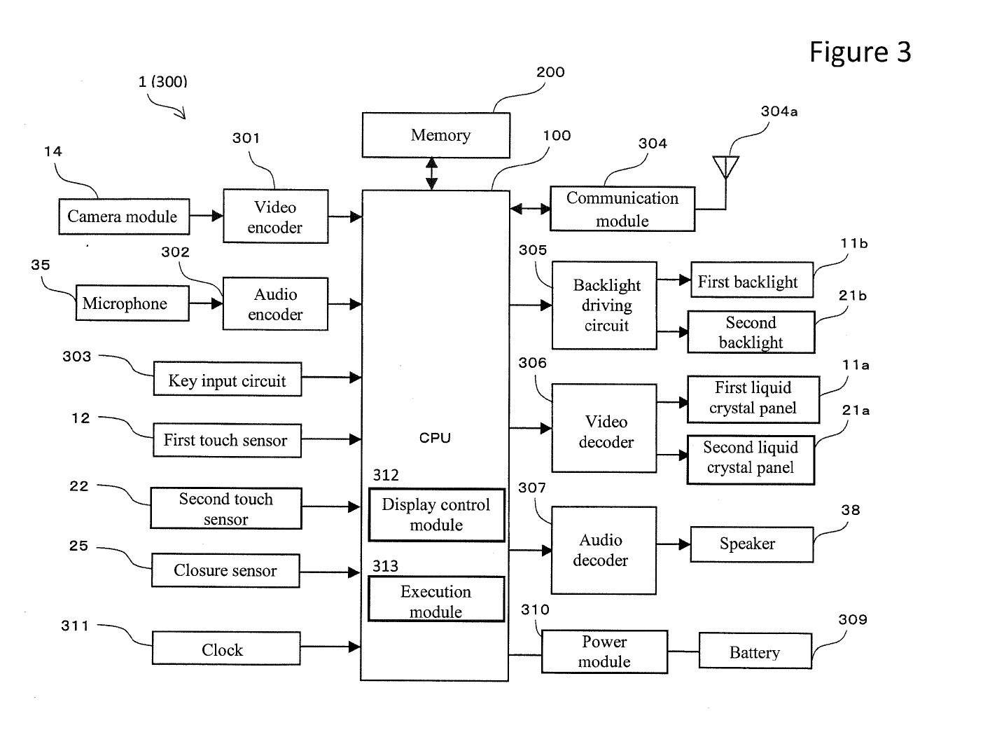

FIG. 3 is an illustration of a functional block diagram of the mobile phone 1 (system 300) according to an embodiment of the disclosure. In addition to the abovementioned components, the mobile phone 1 comprises the CPU 100, a memory 200, a video encoder 301, an audio encoder 302, a key input circuit 303, a communication module 304, a backlight driving circuit 305, a video decoder 306, an audio decoder 307, a battery 309, a power module 310, and a clock 311.

The camera module 14 comprises an imaging element such as a charge-coupled device (COD). The camera module 14 digitalizes imaging signals output from the imaging element, implements various corrections such as gamma correction on the imaging signals, and outputs them to the video encoder 301. The video encoder 301 implements an encoding process on the imaging signals from the camera module 14 and outputs them to the CPU 100.

The microphone 35 converts collected audio into audio signals and outputs them to the audio encoder 302. The audio encoder 302 converts the analog audio signals from the microphone 35 into digital audio signals, implements an encoding process on the digital audio signals, and outputs them to the CPU 100.

When individual keys such as the power key 36 or the hard keys 37 are pressed, the key input circuit 303 outputs input signals corresponding to each key to the CPU 100.

The communication module 304 converts data from the CPU 100 into wireless signals and transmits them to a base station via an antenna 304a. Moreover, the communication module 304 converts wireless signals received via the antenna 304a into data and outputs the data to the CPU 100.

The backlight driving circuit 305 feeds drive signals corresponding to control signals from the CPU 100 to the first backlight 11b and the second backlight 21b. The first backlight 11b lights up as a result of the drive signals from the backlight driving circuit 305 and illuminates the first liquid crystal panel 11a. The second backlight 21b lights up as a result of the drive signals from the backlight driving circuit 305 and illuminates the second liquid crystal panel 21a.

The video decoder 306 converts image data from the CPU 100 into video signals that can be displayed on the first liquid crystal panel 11a and the second liquid crystal panel 21a, and outputs the signals to the liquid crystal panels 11a, 21a. The first liquid crystal panel 11a displays images corresponding to the video signals on the first display screen 11a1. The second liquid crystal panel 21a displays images corresponding to the video signals on the second display screen 21a1.

The audio decoder 307 implements a decoding process on audio signals from the CPU 100 as well as sound signals of various notifications such as ring alerts and alarms, and then converts the signals into analog signals and outputs them to the speaker 38. The speaker 38 plays back the sound signals from the audio decoder 307.

The battery 309 is for feeding power to the CPU 100 and to each part other than the CPU 100, and is composed of a secondary battery. The battery 309 is connected to the power module 310.

The power module 310 converts the voltage of the battery 309 into voltage of the sizes required for each part and feeds the voltage to each part. Moreover, the power module 310 feeds power fed via an external battery (not shown) to the battery 309 to recharge the battery 309.

The clock 311 measures time and outputs signals corresponding to the measured time to the CPU 100.

The memory 200 may be any suitable data storage area with suitable amount of memory that is formatted to support the operation of the system 300. Memory 200 is configured to store, maintain, and provide data as needed to support the functionality of the system 300 in the manner described below. In practical embodiments, the memory 200 may comprise, for example but without limitation, a non-volatile storage device (non-volatile semiconductor memory, hard disk device, optical disk device, and the like), a random access storage device (for example, SRAM, DRAM), or any other form of storage medium known in the art. The memory 200 may be coupled to the CPU 100 and configured to store, for example but without limitation, control programs for assigning control functions to the CPU 100.

The control programs may comprise a control program that, when an application for which duplicate startup is prohibited is already being executed with either the first display 11 or the second display 21 as the output destination, if a prescribed input related to the application is made on the other display, causes the screen of the application to be displayed on the other display. Prescribed inputs related to an application include operations for directly or indirectly executing an application and using the application. For example, when an operation to send an image through E-mail is performed using an application that displays images (described later), this operation is a prescribed input related to an E-mail application.

The memory 200 stores various applications including calls, E-mail, a web browser, video display, image display, and an address book. Apps for which duplicate startup is prohibited (e.g., the applications for calls, video display, E-mail, and the address book) are assigned information regarding the prohibition of duplicate startup. When multiple processes are executed in parallel due to duplicate startups of applications for calls and video display, there may be competition for the output of audio data that causes an error.

In the memory 200, data such as audio data, image data, and text data are saved in prescribed file formats. Examples of such data include data on photographs captured by the camera module 14, data input through the various touch sensors 12, 22, and data fetched from an external source via the communication module 304.

The memory 200 stores information such as display information on images displayed on each display screen. The images comprise a picture, such as an icon, button, or photograph, as well as text input in a text region. The display information comprises information on images displayed on each display screen, as well as the position at which each image is displayed on each display screen. Information on images representing processes, such as icons or buttons, comprises processing targets such as applications or files as well as processing details such as start or end. Information on images for which a hyperlink is set comprises processing targets such as applications for displaying the saved locations of reference information and for displaying reference information, as well as processing details for displaying reference information using the application that is the processing target.

The CPU 100 comprises an execution module 313 and a display control module 312. Based on input signals from the key input circuit 303 as well as position signals from each touch sensor, the CPU 100 is able to operate the camera module 14, the microphone 35, the communication module 304, the liquid crystal panels 11a, 21a, and the speaker 38, etc. in accordance with the control programs. As a result, the CPU 100 is able to execute various applications for calls and E-mail, etc.

An operation module such as each touch sensor 12, 22 receives a start operation performed by a user. The start operation may comprise a startup of an application program that is unable to start due to duplication.

The display control module 312 (control module) terminates a display of a first screen image on the first display module 11 and displays a second screen image on a second display module 21, when the start operation is received while the first screen image is displayed on the first display module 11. The first screen image is based on the application program and the second screen image is based on a duplicate program of the application program.

The execution module 313 is able to execute applications selected by the user. The execution module 13 executes a first application program and a duplicate program of the first application program in response to the inputs on the first display module 11 and the second display module 21.

The execution module 313 receives position signals from each touch sensor 12, 22, (detection modules 12 and 22)and identifies the image displayed at the input position indicated by the position signals based on the display information of the memory 200. The execution module 313 reads out the application or file that is the processing target according to the information of the identified image from the memory 200 and starts up the application.

For example, if the user touches the icon for E-mail, the execution module 313 executes the E-mail application. As a result of the functions of the executed application, it becomes possible to create and transmit and receive E-mails. As a result, E-mails that are created and transmitted and received are displayed on the display screens 11a1, 21a1 by the display control module 312.

If the user touches the icon of an image data folder, the execution module 313 executes (starts up) an application for displaying images. Image data are read out from the memory 200 by the executed application, and the image data are then adjusted to a format meeting the display conditions, such as a format for thumbnail images. A list of thumbnail images is displayed on the display screens 11a1, 21a1 by the display control module 312.

Furthermore, if the user touches the icon for a web browser, the execution module 313 starts up the web browser. Data are received via the communication module 304 by the web browser that has been started up, and the received data are adjusted to modes that can be displayed on the display screens 11a1, 21a1. As a result, webpages based on the received data are displayed on the display screens 11a1, 21a1 by the display control module 312.

For applications for which duplicate startup is allowed, multiple execution operations are possible. Each time an execution operation is performed, a new process is started by the application and multiple processes are executed in parallel. Screens based on the multiple processes are each displayed on the display screens 11a1, 21a1 by the display control module 312.

On the other hand, for applications for which duplicate startup is prohibited, only one process can be executed at a single time. Therefore, when an operation is performed to newly start up an application identical to an application that has already been started up, the CPU 100 saves the processing details of the application already being executed in the memory 200 and then ends the application that has already been started up. The execution module 313 starts up the new application and causes the newly started up application to execute processes corresponding to the new operating details.

The display control module 312 is able to output control signals to the video decoder 306 and the backlight driving circuit 305. For example, the display control module 312 controls the backlight driving circuit 305 and turns off the backlights 11b, 21b. On the other hand, the display control module 312 turns on the backlights 11b, 21b and also controls the video decoder 306 and causes each display screen to display images. The display control module 312 is also able to control the contrast, brightness, screen size, and screen transparency used when displaying images on each display screen.

For example, the display control module 312 is able to display a screen based on an application executed by the execution module 313. The display control module 312 is able to set the output destination of the screen based on the application to the first display 11 or the second display 21 in accordance with the user operations. For example, if the user touches an icon on the first display screen 11a1, the application corresponding to the icon is executed by the execution module 313. The output destination of the executed application is set to the first display 11, and the screen of the application is displayed on the first display screen 11a1. Moreover, if an operation is performed to newly execute an application for which duplicate startup is prohibited that is already being executed, the output destination of the application screen is switched.

The display control module 312 is further operable to store information in the first screen image, end the application program, and start the duplicate program of the application program, in response to the operation module receiving the start operation.

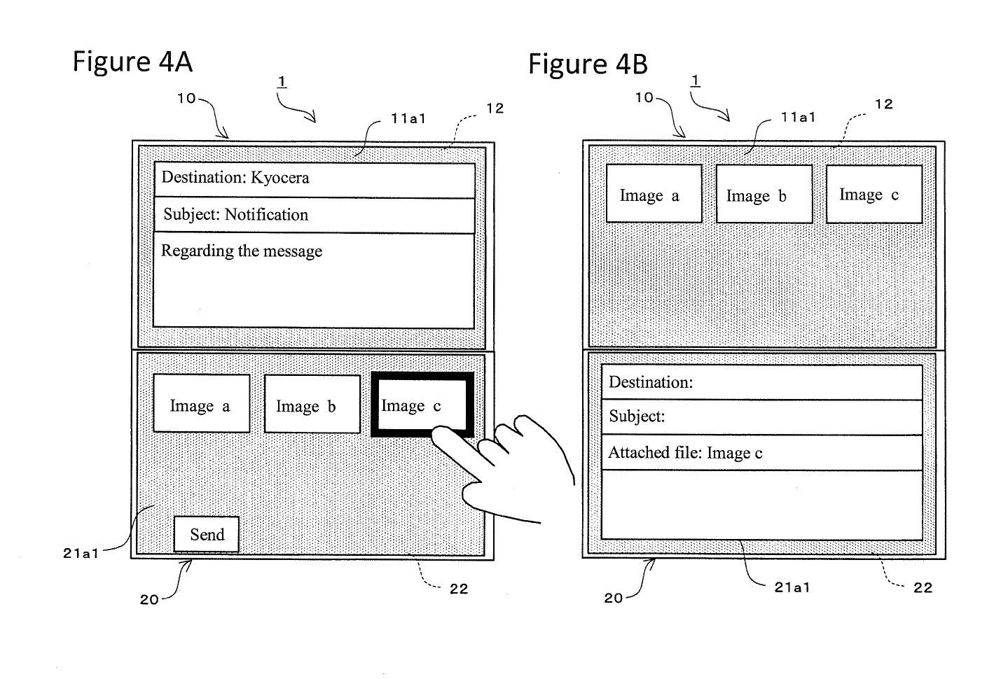

As shown in FIG. 4A, if an E-mail application is being executed with the first display screen 11a1 as the output destination, the display control module 312 causes the first display screen 11a1 to display a screen for creating an E-mail. The E-mail creation screen is provided with fields for the E-mail destination, the subject, and the body text, and text regions are arranged in each of these fields. Information input by the user is input into the text regions and displayed.

If an image-display application saved in the memory 200 is being executed with the second display screen 21a1 as the output destination, the display control module 312 causes the second display screen 21a1 to display the list of thumbnail images of images read out from the memory 200.

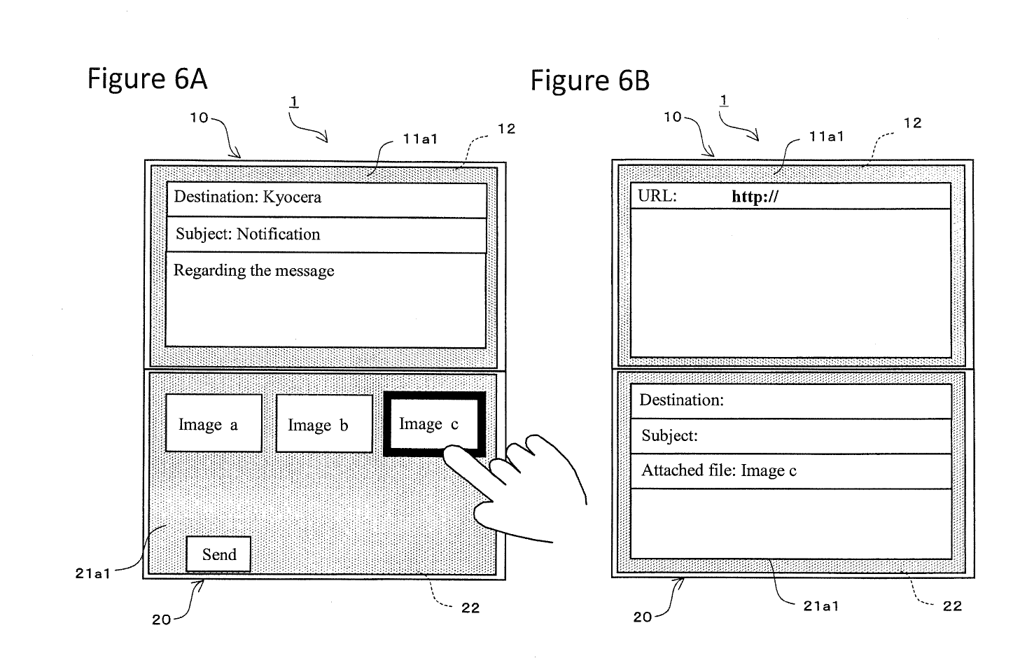

Furthermore, as shown in FIG. 6B, if a web browser is being executed with the first display screen 11a1 as the output destination, webpages are displayed on the first display screen 11a1.

FIGS. 4A-4B are illustration of display screens showing E-mail creation screens and a screen listing thumbnail images on the display screens. FIG. 4A shows the E-mail creation screen is displayed on the first display screen 11a1 and the screen listing thumbnail images is displayed on the second display screen 21a1. FIG. 4B shows the screen listing thumbnail images is displayed on the first display screen 11a1 and the E-mail creation screen is displayed on the second display screen 21a1.

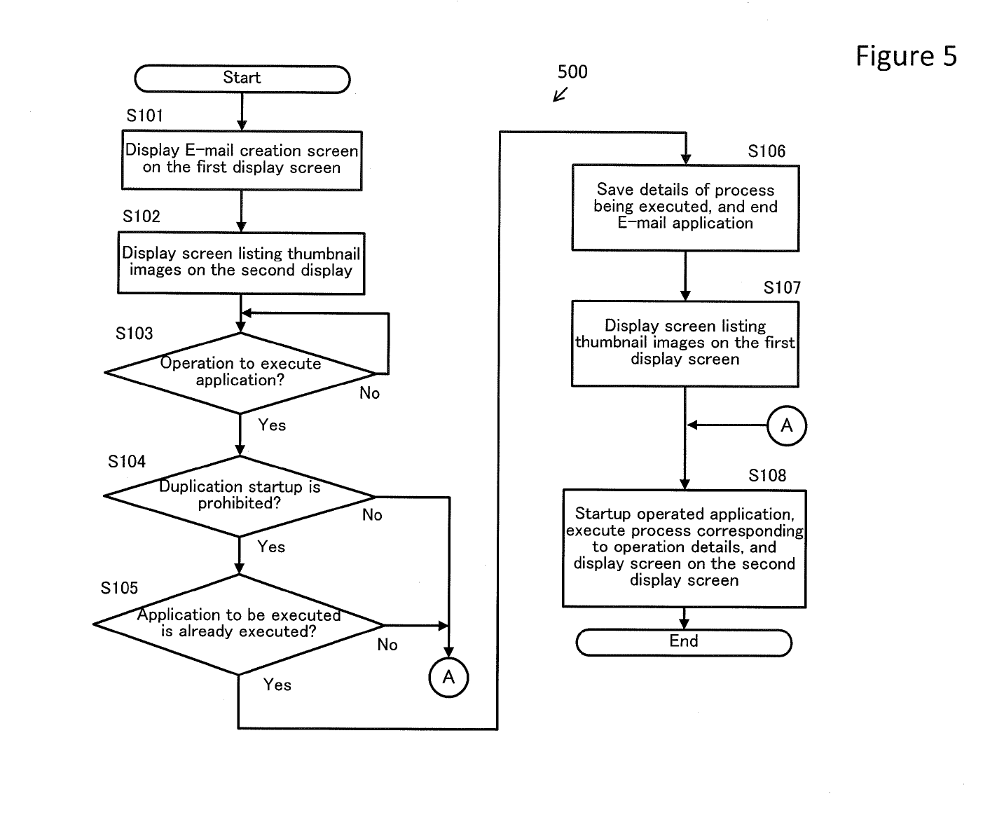

FIG. 5 is an illustration of a flowchart showing a screen display control process 500 (process 500) for executing a duplicate application program according to an embodiment of the disclosure. The various tasks performed in connection with the process 500 may be performed by software, hardware, firmware, a computer-readable medium having computer executable instructions for performing the process method, or any combination thereof. The process 500 may be recorded in a computer-readable medium such as a semiconductor memory, a magnetic disk, an optical disk, and the like, and can be accessed and executed, for example, by a computer CPU such as the CPU 100 in which the computer-readable medium is stored.

It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein. In practical embodiments, portions of the process 500 may be performed by different elements of the system 300. Process 500 may have functions, material, and structures that are similar to the embodiments shown in FIGS. 1-4. Therefore common features, functions, and elements may not be redundantly described here.

Process 500 shows a process for switching to the display state shown in FIG. 4B when an input using the E-mail application is detected by the second touch sensor in the display state of FIG. 4A.

When a function for controlling an application for which duplicate startup is prohibited is set, a process that controls the application is executed by the CPU 100. In this control process, in response to user operations, the application is started up and ended, and the output destination of the application screen is set.

As shown in FIG. 4A, the E-mail application is executed with the first display screen 11a1 as the output destination, and the E-mail creation screen is displayed on the first display screen 11a1 (task S101). The image-display application is executed with the second display screen 21a1 as the output destination, and the screen listing thumbnail images is displayed on the second display screen 21a1 (task S102).

The CPU 100 monitors whether or not operations for executing a new application are performed in the screen of the application executed with the first display screen 11a1 as the output destination and the screen of the application executed with the second display screen 21a1 as the output destination (task S103).

In the screen listing thumbnail images, three thumbnail images a-c of the images A-C and a button labeled “Send” (hereinafter referred to as the “Send button”) are displayed.

If the user wishes to deliver the image C via E-mail, first, the user touches the thumbnail image c. At this time, the line width of the border of the thumbnail image c becomes thick and the thumbnail image c is highlighted. Next, when the Send button is touched by the user, destinations are displayed. As destinations, destination items for E-mail, a website, a contact, and wallpaper settings, etc. are displayed. When the user selects E-mail from among the destination items, it is determined that an operation to execute the E-mail application has been performed (task S103: YES).

The CPU 100 determines whether or not the executed application is an application for which duplicate startup is prohibited (task S104). If the application is an application for which duplicate startup is prohibited (task S104: YES), the CPU 100 determines whether or not the application is already being executed (task S105). Here, the E-mail application for which an execution operation has been performed has been assigned information regarding the prohibition of duplicate startup (task S104: YES). Moreover, the E-mail application is already being executed with the first display screen 11a1 as the output destination (task S105: YES). Therefore, the execution module 313 is unable to execute the E-mail application in response to the execution operation performed by the user.

Therefore, the CPU 100 saves the details of processes currently being executed in the memory 200 and ends the E-mail application being executed (task S106). As a result, the details of the E-mail destination, subject, and body text can be read out later. For example, after the newly executed E-mail application is ended, when a prescribed operation is performed, the CPU 100 is able to display the saved details of the E-mail destination, subject, and body text on the first display screen 11c. The prescribed operation refers to, for example, operations instructing the execution of the E-mail application with the first display screen 11c as the output destination. After the newly executed E-mail application is ended, if the CPU 100 receives an operation for executing the E-mail application via the first touch sensor 12, it may start up the E-mail application again and cause the first display screen 11c to display the saved details of the E-mail destination, subject, and body text. In this case, the CPU 100 may display the first display screen 11a1 of FIG. 4A again.

When the E-mail application is ended, the output destination of the image-display application is switched from the second display 21 to the first display 11 and the screen listing thumbnail images is displayed on the first display screen 11a1 (task S107).

Moreover, the E-mail application is newly executed with the second display screen 21a1 as the output destination, and a process corresponding to the operation details for sending the image c is executed. As a result, the E-mail creation screen is displayed on the second display screen 21a1, and the image C is displayed on the E-mail creation screen as an attached file (task S108).

If the application that the user is trying to execute is an application for which duplicate startup is possible (task S104: NO), or if the application is an application for which duplicate startup is prohibited but is not being executed (task S105: NO), the application is executed in response to user operations and the screen of the executed application is displayed on the second display screen 21a1 (task S108). In the above description, as an example, the screen of the executed application is displayed on the second display screen, but it may be displayed on the first display screen 11a1.

As described above, according to FIG. 5, even if an E-mail application for which duplicate startup is prohibited is already being executed with the first display screen 11a1 as the output destination, if the user performs an operation to execute the E-mail application on the second display screen 21a1, the E-mail application is executed with the second display screen 21a1 as the output destination. As a result, the user does not need to end the application being executed and execute the application again, and this may provide excellent operability.

In the screen listing images on the second display screen 21a1, if the user selects the button for delivering an image by E-mail, the E-mail creation screen is displayed on the second display screen 21a1 being operated. In other words, on the display screen being operated, an application screen based on that operation is displayed. Therefore, the user is able to continue operations in the same display screen without changing the display screen being operated, and this may provide excellent convenience.

In the E-mail creation screen displayed on the second display screen 21a1, the image C is displayed as an attached file. In this way, the details of operations performed before the E-mail application is executed with the second display screen 21a1 as the output destination are reflected in the executed E-mail application, and this may provide excellent convenience.

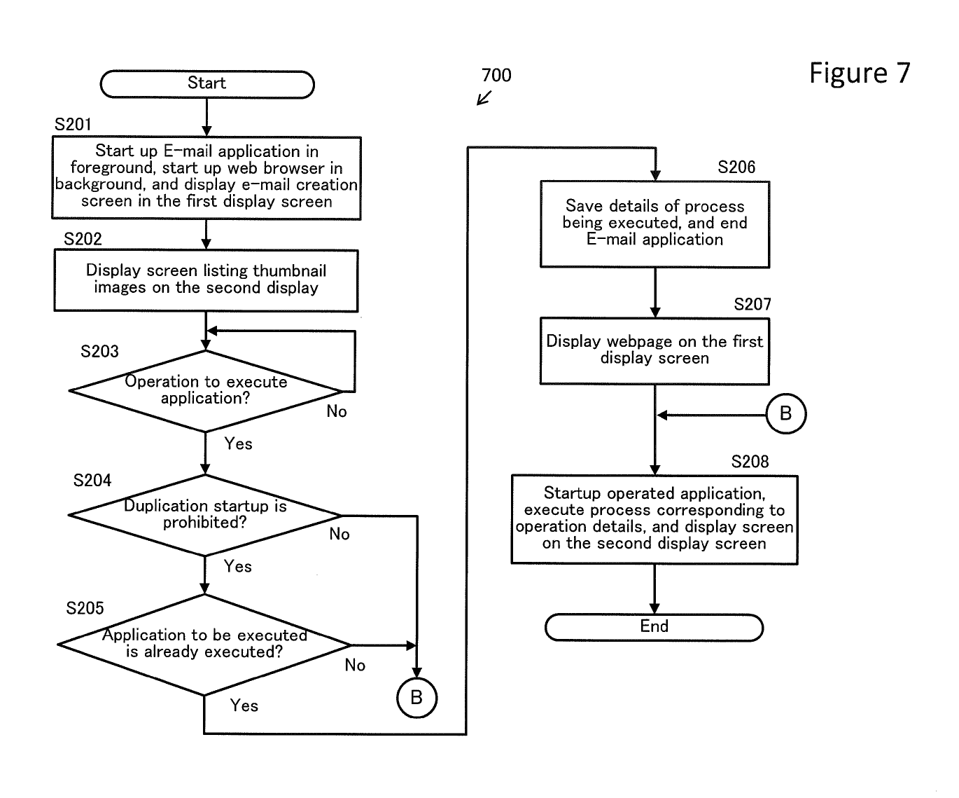

In FIG. 5, there was one application using the first display screen 11a1 as the output destination. In contrast, a case in which multiple applications using the first display screen 11a1 as the output destination will be described with reference to FIG. 6 and FIG. 7. FIGS. 6A-6B are illustrations of display screens showing an E-mail creation screen, a screen listing thumbnail images, and a webpage screen according to embodiments of the disclosure.

FIG. 6A shows an E-mail creation screen is displayed on the first display screen 11a1 and the screen listing images is displayed on the second display screen 21a1. With the first display screen 11a1 as the output destination, the E-mail application is executed in the foreground and the web browser is executed in the background, and the screen of the E-mail application is displayed on the first display screen 11a1.

FIG. 6B shows a webpage is displayed on the first display screen 11a1 and the E-mail creation screen is displayed on the second display screen 21a1.

As shown FIGS. 6A and 6B, multiple applications may be executed using a single display screen as the output destination. In this case, of the screens based on the multiple applications, one screen is displayed on one of the display screens 11a1, 21a1.

FIG. 7 is an illustration of a flowchart showing a screen display control process 700 (process 700)for executing a duplicate application program according to an embodiment of the disclosure. Process 700 shows a processing procedures for switching to the display state shown in FIG. 6B when, in the display state shown in FIG. 6A, an operation to use the E-mail application is detected by the second touch sensor 22.

The various tasks performed in connection with the process 700 may be performed by software, hardware, firmware, a computer-readable medium having computer executable instructions for performing the process method, or any combination thereof. The process 700 may be recorded in a computer-readable medium such as a semiconductor memory, a magnetic disk, an optical disk, and the like, and can be accessed and executed, for example, by a computer CPU such as the CPU 100 in which the computer-readable medium is stored.

It should be appreciated that process 700 may include any number of additional or alternative tasks, the tasks shown in FIG. 7 need not be performed in the illustrated order, and process 700 may be incorporated into a more comprehensive procedure or process having additional functionality not described in detail herein. In practical embodiments, portions of the process 700 may be performed by different elements of the system 300. Process 700 may have functions, material, and structures that are similar to the embodiments shown in FIGS. 1-6. Therefore common features, functions, and elements may not be redundantly described here.

As shown FIG. 6A, with the first display screen 11a1 as the output destination, the E-mail application is executed in the foreground and the web browser is executed in the background, and the screen of the E-mail application is displayed on the first display screen 11a1 (task S201). WebPages opened by the web browser are not displayed.

Moreover, the image-displaying application is executed with the second display screen 21a1 as the output destination, and the screen listing thumbnail images is displayed on the second display screen 21a1 (task S202).

When the thumbnail image c and the Send button are touched on the second display screen 21a1, items for the destination is displayed. When E-mail is selected from among the items for the destination, an operation to execute the E-mail application with the second display screen 21a1 as the output destination is performed (task S203: YES).

The E-mail application has a prohibition on duplicate startup (task S204: YES) and is already being executed with the first display screen 11a1 as the output destination (task S205: YES). Therefore, once the details of processes being executed are saved in the memory 200, the E-mail application being executed is ended (task S206).

As shown in FIG. 6B, once the E-mail application being executed is ended, the webpage provided by the web browser already being executed in the background with the first display screen 11a1 as the output destination is displayed on the first display screen 11a1 (task S207).

Moreover, the E-mail application that was executed in S203 is newly executed with the second display screen 21a1 as the output destination, the E-mail creation screen is displayed on the second display screen 21a1, and the image C is already displayed in the E-mail creation screen as an attached file (task S208).

As described above, according to FIG. 7, as with FIG. 6, even if an application for which duplicate startup is prohibited is already being executed, when an operation to execute the application is performed in the other display screen, the application is executed with the operated display screen as the output destination, which may provide excellent operability. Moreover, it is possible to continue operating on the display screen on which the execution operation was performed, and this may provide excellent convenience. Furthermore, the details of operations performed before the application is newly executed are reflected in the newly executed application, and this may provide excellent convenience.

As shown in FIG. 6 and FIG. 7, when the E-mail application is ended, a webpage is displayed on the first display screen 11a1 instead of the E-mail creation screen. In this way, if multiple applications are being executed with the first display screen 11a1 as the output destination, when one application is ended, the screen of another application is displayed on the first display screen 11a1. Therefore, no operation for displaying the screen of another application is required, and this provides excellent convenience.

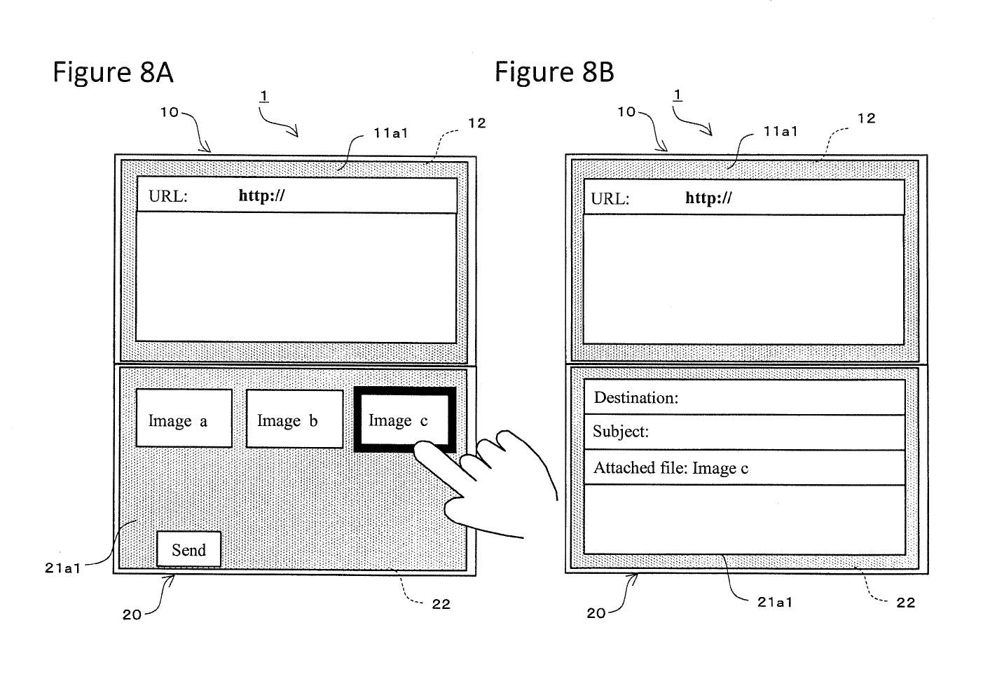

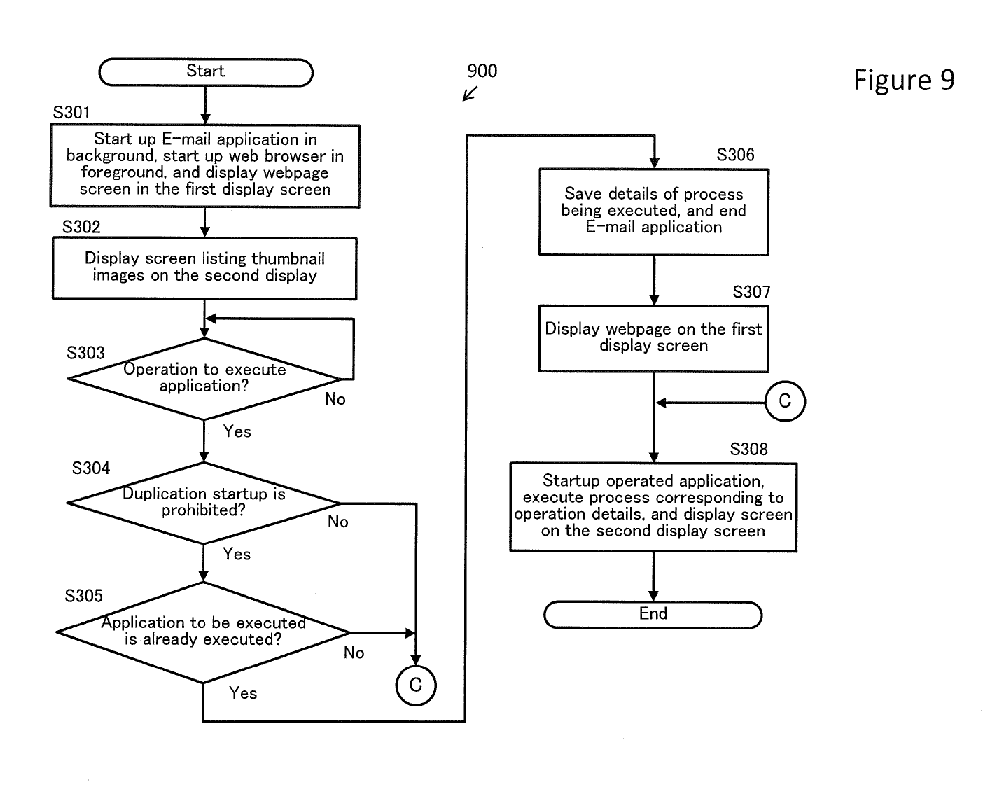

In FIGS. 8A-8B and FIG. 9, as with FIGS. 6A-6B and FIG. 7, multiple applications are being executed with the first display screen 11a1 as the output destination. However, while the E-mail application screen is displayed on the first display screen 11a1 in FIG. 6 and FIG. 7, in FIGS. 8A, 8B and FIG. 9, the screen of an application other than the E-mail application is displayed on the first display screen 11a1.

FIGS. 8A-8B are illustrations of display screens showing E-mail creation screens, screens listing thumbnail images, and webpage screens according to embodiments of the disclosure. FIG. 8A shows the webpage is displayed on the first display screen 11a1 and the screen listing images is displayed on the second display screen 21a1 FIG. 8B shows the webpage is displayed on the first display screen 11a1 and the E-mail creation screen is displayed on the second display screen 21a1.

FIG. 9 is an illustration of a flowchart showing a screen display control process 900 (process 900) for executing a duplicate application program according to an embodiment of the disclosure. Process 900 shows the processing procedures for switching to the display state shown in FIG. 8B when, in the display state shown in FIG. 8A, an operation to use the E-mail application is detected by the second touch sensor 22.

The various tasks performed in connection with the process 900 may be performed by software, hardware, firmware, a computer-readable medium having computer executable instructions for performing the process method, or any combination thereof. The process 900 may be recorded in a computer-readable medium such as a semiconductor memory, a magnetic disk, an optical disk, and the like, and can be accessed and executed, for example, by a computer CPU such as the CPU 100 in which the computer-readable medium is stored.

It should be appreciated that process 900 may include any number of additional or alternative tasks, the tasks shown in FIG. 9 need not be performed in the illustrated order, and process 900 may be incorporated into a more comprehensive procedure or process having additional functionality not described in detail herein. In practical embodiments, portions of the process 900 may be performed by different elements of the system 300. Process 900 may have functions, material, and structures that are similar to the embodiments shown in FIGS. 1-8. Therefore common features, functions, and elements may not be redundantly described here.

With the first display 11 as the output destination, the web browser is executed in the foreground and the E-mail application is executed in the background, and the webpage opened by the web browser is displayed on the first display screen 11a1 (task S301). Moreover, with the second display 21 as the output destination, the image-displaying application is executed and the screen listing thumbnail images is displayed on the second display screen 21a1 (task S302).

When an operation is performed on the second display screen 21a1 to deliver an image via E-mail (task S303: YES), once the details of processes being executed with the first display screen 11a1 as the output destination are saved, the E-mail application being executed in the background is ended (task S304: YES; task S305: YES; task S306). Even after the E-mail application is ended, because the webpage is already being displayed on the first display screen 11a1, the webpage continues to be displayed (task S307). Then, the E-mail application is newly executed, and the E-mail creation screen is displayed on the second display screen 21a1 (task S308).

According to FIG. 8 and FIG. 9, even when an application for which duplicate startup is prohibited is already being executed, if an operation is performed in another display screen to execute the application, the application is executed with the operated display screen as the output destination, which may provide excellent operability. It is possible to continue operating the display screen on which the execution operation was performed, and this may provide excellent convenience. The details of operations performed before the application is newly executed are reflected in the newly executed application, and this may provide excellent convenience.

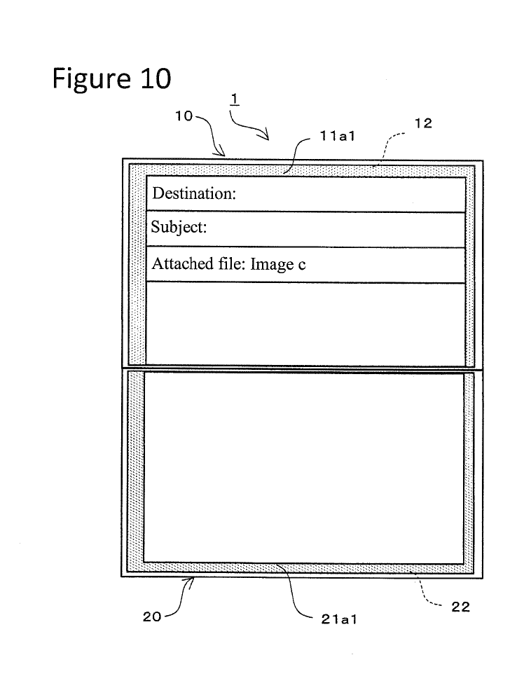

The above embodiments are exemplary in nature and are not intended to limit the disclosure or the application and uses of the embodiments of the disclosure. For example, if the user performs an operation to execute the E-mail application with the second display screen 21a1 as the output destination, the E-mail creation screen is displayed on the second display screen 21a1 as shown FIGS. 4B, 6B, and 8B. In contrast, as shown FIG. 10, the E-mail creation screen may be displayed on not only the second display screen 21a1 but also the first display screen 11a1 as well to be displayed across the entirety of both display screens. As a result, because the operation screen intended by the user is displayed and the operation screen is displayed across a broad field, this may make operation easier.

If an operation to execute the E-mail application is performed on the second display screen 21a1, the details of operations of the E-mail application already being executed with the first display screen 11a1 as the output destination are saved and the application is ended once. Then, the E-mail application is executed again and the E-mail creation screen is displayed on the second display screen 21a1. In contrast, if an operation to execute the E-mail application is performed on the second display screen 21a1, the details of operations of the E-mail application already being executed are saved. Then, without ending the application, the output destination of the application screen may be switched from the first display screen 11a1 to the second display screen 21a1, and the E-mail creation screen may be displayed on the second display screen 21a1.

If an operation to execute an application is performed on the first display screen 11a1, the output destination of the screen of the application is set to the first display 11 and the screen of the application is displayed on the first display screen 11a1. In contrast, images for selecting the output destination of screens may be displayed on the display screens 11a1, 21a1, and the output destination of screens may be set by the user selecting an image. As a result, it is possible to perform operations on the second display screen 21a1 to execute an application and display the screen on the first display screen 11a1.

In this document, the terms “computer program product”, “computer-readable medium”, and the like may be used generally to refer to media such as, for example, memory, storage devices, or storage unit. These and other forms of computer-readable media may be involved in storing one or more instructions for use by the CPU 100 to cause the CPU 100 to perform specified operations. Such instructions, generally referred to as “computer program code” or “program code” (which may be grouped in the form of computer programs or other groupings), when executed, enable a method of executing a duplicate application program.

Terms and phrases used in this document, and variations hereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile electronic device comprising:
an operation module operable to receive a start operation performed by a user, the start operation comprising a startup of a first application program that is unable to start due to duplication; and
a control module operable to terminate a display of a first screen image on a first display module and display a second screen image on a second display module, when the start operation is received while the first screen image is displayed on the first display module, the first screen image based on the first application program, the second screen image based on a newly started up first application program.

2. The mobile electronic device according to claim 1, further comprising:
a memory operable to store information in the first screen image, wherein
the control module stores the information in the first screen image in the memory, ends the first application program, and newly starts the first application program, in response to the operation module receiving the start operation.

3. The mobile electronic device according to claim 2, wherein the control module is further operable to cause the first display module to display the first screen image, when the newly started up first application program terminates.

4. The mobile electronic device according to claim 1, wherein the operation module comprises a second touch panel operable to detect the start operation on the second display module.

5. The mobile electronic device according to claim 4, wherein the control module is further operable to:
terminate the display of the first screen image on the first display module in response to the operation module receiving the start operation on the second display module; and
cause the second display module to display the second screen image.

6. The mobile electronic device according to claim 1, wherein the operation module comprises a first touch panel operable to detect the start operation on the first display module.

7. The mobile electronic device according to claim 6, wherein the control module is further operable to cause the first display module to display the first screen image, when the newly started up first program terminates and the start operation is detected.

8. A mobile electronic device comprising:
a first detection module operable to detect inputs on a first display module;
a second detection module operable to detect the inputs on a second display module;
an execution module operable to execute a first application program that can't be newly executed while being executed; and
a display control module operable to cause the second display module to display a first screen image based on the first program,
when the second detection module detects a startup operation while the first program is being executed by the execution module for displaying on the first display module.

9. The mobile electronic device according to claim 8, wherein the display control module is further operable to cause the second display module to display the first screen image instead of the first display module, when the first screen image is being displayed on the first display module and a prescribed input is detected by the second detection module.

10. The mobile electronic device according to claim 8, wherein
the display control module is further operable to display the first screen image on the second display module and display a second screen image on the first display module, when a prescribed input related to the first program is detected by the second detection module while the first screen image based on the first program is being displayed on the first display module and the second screen image based on a second program different from the first application program is being displayed on the second display module.

11. The mobile electronic device according to claim 8, wherein
the display control module is further operable to cause the first display module and the second display module to display the first screen image, when a prescribed input related to the first application program is detected by the second detection module while the first screen image based on the first application program is being displayed on the first display module and a second screen image based on a second application program different from the first application program is being displayed on the second display module.

12. The mobile electronic device according to claim 8, wherein
the display control module is further operable to cause the second display module to display the first screen image and cause the first display module to display a third screen image, when the first screen image based on the first application program is being displayed on the first display module, a second screen image based on a second application program different from the first application program is being displayed on the second display module, and an output destination of the third screen image based on a third application program different from the first application program and the second application program is set to the first display module.

13. The mobile electronic device according to claim 8, wherein
when an output destination of the first screen image based on the first application program is set to the first display module, a second screen image based on a second application program different from the first application program is displayed on the second display module, and a third screen image based on a third application program different from the first application program is displayed on the first display module, if a prescribed input related to the first application program is detected by the second detection module, the display control module causes the second display module to display the first screen image.

14. A computer readable storage medium comprising computer-executable instructions for executing a duplicate application program, the method executed by the computer-executable instructions comprising:
receiving a start operation performed by a user, the start operation related to a startup of a first application program unable to start due to duplication; and
terminating a display of a first screen image on a first display module and displaying of a second screen image on a second display module, when the start operation is received while the first screen image is displayed on the first display module, the first screen image based on the first application program, the second screen image based on the newly started up first application program.

15. The computer readable storage medium according to claim 14, the method executed by the computer-executable instructions further comprising:
storing information in the first screen image, ending the first application program, and newly starting the first application program, in response to receiving the start operation.

16. The computer readable storage medium according to claim 14, the method executed by the computer-executable instructions further comprising:
displaying the first screen image, when the newly started up first program terminates.

17. The computer readable storage medium according to claim 14, the method executed by the computer-executable instructions further comprising:
receiving the start operation on the second display module;
terminating the display of the first screen image on the first display module in response to receiving the start operation on the second display module; and
causing the second display module to display the second screen image.

18. A computer readable storage medium comprising computer-executable instructions for controlling a screen display, the method executed by the computer-executable instructions comprising:
displaying a first screen image based on a duplicate program of a first application program on a second display module, when the duplicate program cannot be newly executed during execution of the first application program and while being executed with a first display module as an output destination and a prescribed input related to the program is detected on the second display module.

19. The computer readable storage medium according to claim 18, the method executed by the computer-executable instructions further comprising:
displaying the first screen image on the second display module instead of the first display module, when the first screen image is being displayed on the first display module and the prescribed input is detected on the second display module.

20. The computer readable storage medium according to claim 19, the method executed by the computer-executable instructions further comprising:
displaying the first screen image on the second display module and display a second screen image on the first display module, when the prescribed input related to the duplicate program is detected on the second display module while the first screen image based on the first program is being displayed on the first display module and the second screen image based on a second program separate from the first application program is being displayed on the second display module.
